(19) United States
(12) Patent Application Publication
(10) Pub. No.: US 2016/0300008 A1
(43) Pub. Date: Oct. 13, 2016

(54) SYSTEM AND METHOD FOR INTERACTING WITH CONSTRUCTION BLOCKS THROUGH AN APPLICATION

(71) Applicants: Tarun Pondicherry, Mountain View, CA (US); Joshua Chan, Menlo Park, CA (US)

(72) Inventors: Tarun Pondicherry, Mountain View, CA (US); Joshua Chan, Menlo Park, CA (US)

(21) Appl. No.: 14/684,317

(22) Filed: Apr. 10, 2015

(51) Int. Cl. G06F 17/50

(52) U.S. Cl. CPC G06F 17/5081; G06F 17/5036

(57) ABSTRACT

A method for organizing construction modules is described. In some embodiments, this includes scanning a first construction module for a first identifying marker, classifying the first construction module based on the first identifying marker, scanning a second construction module for a second identifying marker, classifying the second construction module based on the second identifying marker, associating the first construction module with the second construction module based on the classification of the first construction module and the classification of the second construction module, and visualizing a construction blueprint based on the association of the first construction module with the second construction module.

### CROSS REFERENCE TO RELATED APPLICATIONS

This application claims the benefit of co-pending U.S. provisional application 61/978,092, filed on Apr. 10, 2014, which is hereby incorporated by reference.

### TECHNICAL FIELD

This invention relates generally to the construction field, and more specifically to a new and useful system and method for interacting with construction blocks through an application in the construction field.

### BACKGROUND

Science and Engineering education is a growing trend in the field of education. There is a growing emphasis to have more children exposed to this field and to develop intuition and experience working the fields of electronics. However, electronics doe to physical attributes do not lend themselves to easy interaction by a child. Most electrical prototyping tools involve use of tiny components which presents a motor skills barrier, a cognitive barrier, and even safety barrier for children and those just being introduced to the field. Additionally, electronics do not provide physical affordances that can be readily understood by those without some prior knowledge. Thus, there is a need in the electronic construction set field to create a new and useful system and method for interacting with construction blocks through an application. This invention provides such a new and useful system and method.

### BRIEF DESCRIPTION OF THE FIGURES

FIG. 1 is a schematic representation of a system of a preferred embodiment;

FIG. 2 is a schematic representation of a cross-sectional view of a module;

FIG. 3 is an image representation of a set of electronic modules;

FIG. 4 is an image representation of an exemplary circuit constructed from the system;

FIGS. 5 and 6 are detailed image representation of exemplary electronic modules;

FIG. 7 is a flowchart representation of a method of a preferred embodiment;

FIG. 8 is an exemplary image representation of capturing an image; and

FIG. 9 is an exemplary rendering of a simulation.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. System for an Interactive Circuit Construction Set

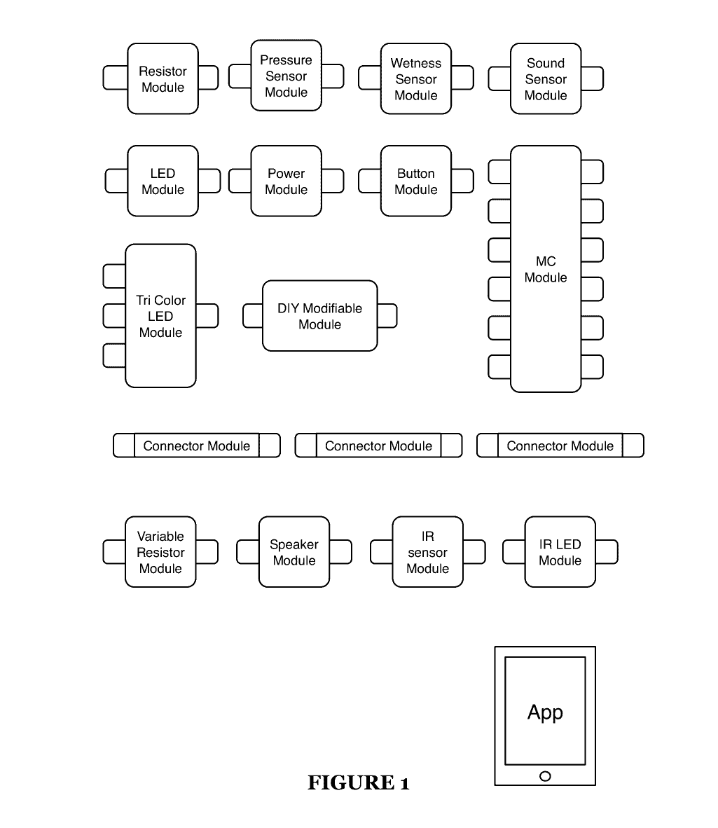

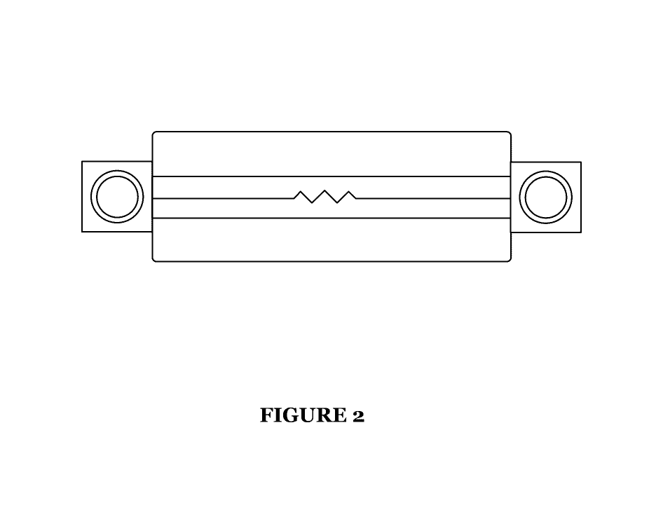

As shown in FIGS. 1 and 2, a system of a preferred embodiment includes a set of electronic modules that include a housing, at least one electronic element segment, and at least one electronic connectors. More preferably the electronic connectors are universal magnetic connectors. A universal magnetic connector comprises a chassis with a defined inner cavity that houses a magnet and an outer surface of the chassis preferably includes an outer conductive cover that is conductively coupled to the electronic element segment. The system functions to provide a set of electronic components that can be easily manipulated to build electronic connections. The electronic modules can act as an individual circuit elements or configured components that can be combined and organized to form customized circuits. In one variation, the set of electronic modules are pre-configured, but the electronic modules may alternatively include partial configuration (e.g., programmable elements, DIP switch control, etc.), or fully configurable electronic elements (e.g., replaceable circuit elements). The set of electronic modules can work in cooperation with an app to provide guided circuit construction information.

The universal magnetic connector is preferably used on all or a substantial number of the electronic modules. The universal connector preferably enables an exposed electrical contact in an electronic connector to be physically couple to another exposed electrical contact of another electronic module. The physical coupling of the electronic modules is preferably primarily promoted through the magnetic attraction between the electronic modules without depending on a physical latching mechanism. In alternative embodiments, the universal magnetic connector can be applied to other construction set applications, including uses that do not depend on an electrical connection. The design of the universal magnetic connector allows polarity of a connector to dynamically adjust to promote magnetic attraction (and physical coupling) between another magnetized element regardless of the polarity of the magnetized element. The universal magnetic connector can additionally allow magnetic attraction steady state to be achieved when one (connected to a ferromagnetic material), two, three or more universal magnetic connectors are positioned to form a connection. The magnets of the universal magnetic connectors preferably self orient themselves (and the coupled component, the electronic module) to a steady state position of attraction. While the universal magnetic connector is preferably applied in forming an electrically conductive coupling between at least two elements, the constructive elements may additionally or alternatively leverage the universal magnetic connectors. For example, construction blocks may use the universal magnetic connectors in addition to or as an alternative to a physical fastening

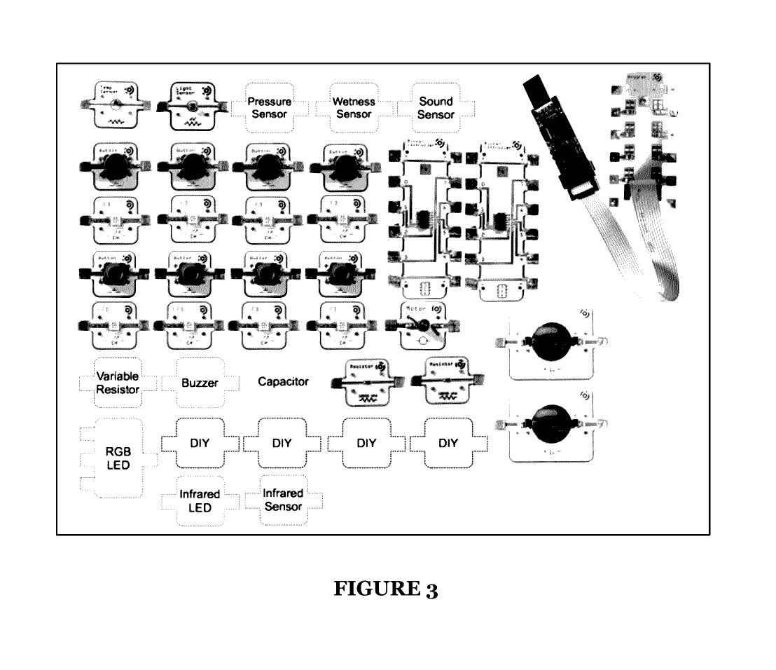

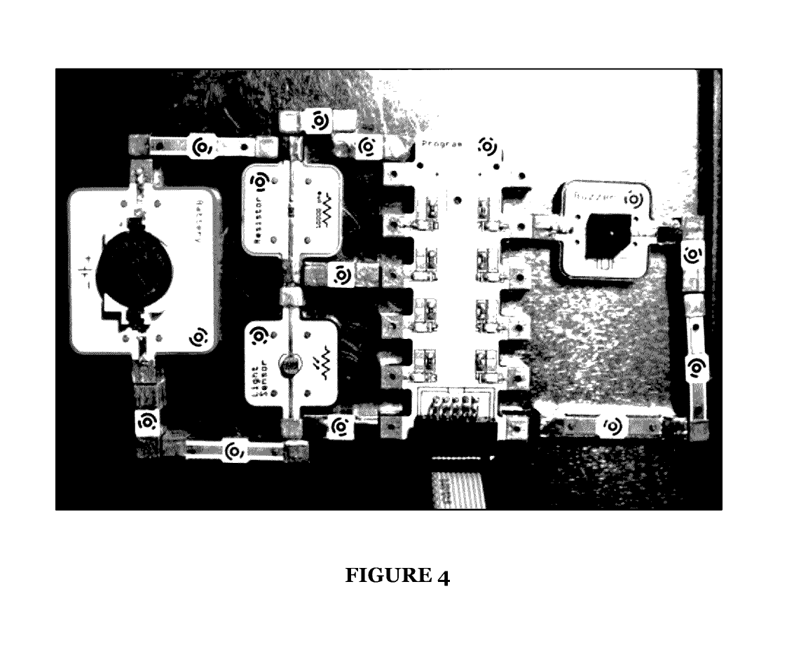

The set of electronic modules function to provide different building block variations when constructing a circuit. The electronic modules are preferably distinct elements that can be manipulated independently as shown in FIG. 3. All or a subset of the electronic modules can be used in constructing a circuit as shown in FIG. 4. The set of electronic modules preferably include a variety of types of circuit elements to be used in combination. Preferably the set of electronic modules can include a variety of resistors, potentiometers, basic conductive connections (e.g., wires), capacitors, magnetic (inductive) devices, diodes, transistors, transducers, sensors, detectors, antennas, switches, speakers, tilt sensors, pressure sensors, microcontrollers, multiplexors, logical gates, LEDs, photosensors, microphones, power sources (e.g., battery), and/or any suitable components. The circuit element could alternatively be configurable such as a do-it-yourself module with a small breadboard for creating a custom module. This list of circuit elements is not an exhaustive list and any suitable electronic element or elements may be used inside the electronic module. The purpose of the set may direct the type of modules. For example, a basic circuit set may include resistors, a power source, LED, and button modules; and a logic set may include an AND gate module, an OR gate module, and a NOT gate module. Additionally multiple, electronic element segments can exist within the set of electronic modules (i.e., two elements share the same housing). A multi-element electronic module preferably includes multiple universal magnetic connectors, wherein at least one connector corresponds to at least one electronic element segment. The elements may share a common universal magnetic connector. Alternatively, a switch or element selector component may exist on the electronic module for a user to “dial in” which element should be selectively coupled to the circuit. In one variation, the set of electronic modules may be designed to work with another prototyping system or any suitable electronic system For example, the set of electronic modules may simply be a variety of different resistors that offer fast switching of circuit elements of a breadboard, printed circuit board, or any suitable circuit. A bridge electronic module may exist that includes one universal magnetic connector and another connector of another medium such as jump wires for a breadboard.

The electronic modules are preferably designed to construct circuits along a 2D plan but the electronic modules may alternatively or additionally enable multilayered construction and/or multidimensional construction.

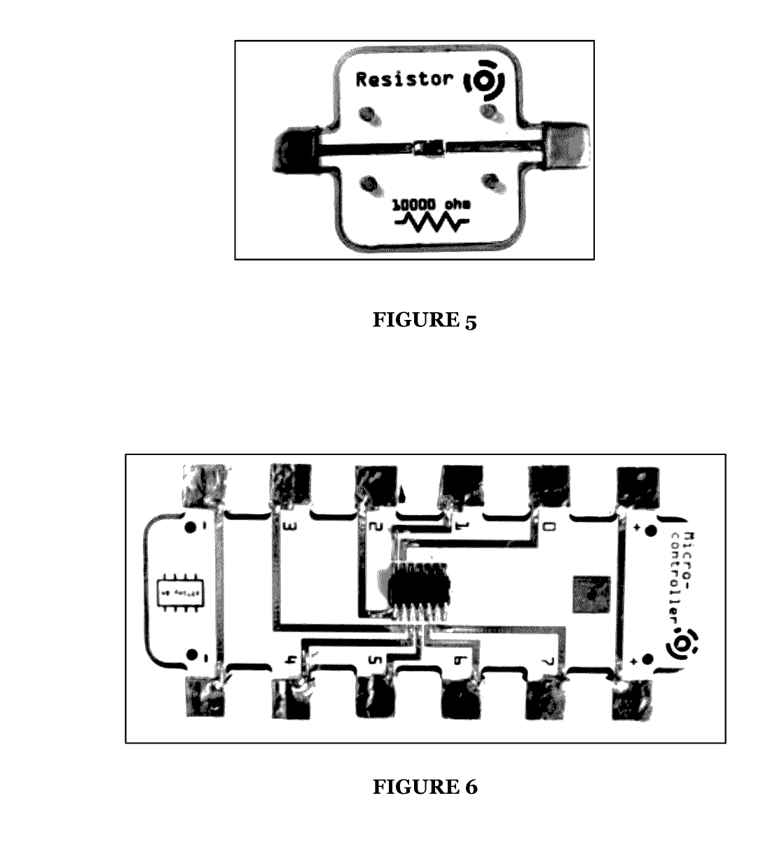

As shown in FIG. 5, the housing is preferably a substantially rigid structure that provides the main mechanical support for the electronic element and the electronic connectors and any suitable element. In one implementation, a clear top portion of the housing exposes the electronic element. The electronic element segment is attached to a printed circuit board fixtured inside the housing between the top portion and a bottom portion of the housing. But any suitable structure may be used. The housing can include a graphical identifier of the element. The graphical identifier may be a graphical representation of the element; information concerning the element such as the elements name, polarity, value, connector labels, and/or any suitable information. Additionally the graphical identifier can include an identifying marker described below, which may be used in combination with an augmented reality (AR) application.

The electronic element segment is preferably the electronic element represented by the electronic module. The electronic element segment is preferably contained in the housing of the electronic module. The electronic element segment can be made of one or more elements even including a simple conductive channel. In one variation, the electronic element can include ports, which may be used for transferring data or power. For example, a battery module can include a USB port through which the battery can be charged. In the battery example, the battery module can additionally include a switch so that the power can be engaged or disengaged. In another variation, a microcontroller module can use a USB port to be programmed and/or communicate with a computing device. The electronic modules may additionally include a communication element to transmit and/or receive data with an external computing device. The communication element can allow electronic modules to be remotely monitored and/or augmented. The communication element can use wifi, Bluetooth, RF, and/or any suitable communication medium. The communication element can be used in combination with an application to transmit properties to the application and/or be updated based on input from the application.

The electronic connectors function to act as the electronic coupling point between the electronic modules. The electronic connectors are preferably conductive and connected to the electronic element segment. There are preferably two connectors but there may alternatively be multiple connectors for various modules as shown in FIG. 6.

The system additionally includes augmented reality (AR) application, which functions to create a simulated circuit view of the electronic modules. The AR application preferably recognizes the electronic modules, approximates the formed circuit, and then graphically presents information about the formed circuit. The AR application can be used in debugging circuits, presenting new lessons, providing physical circuit interactions through the AR application. The AR application is preferably operable on a mobile computing device with a camera or a suitable imaging system. In this system variation, the electronic modules can include identifying markers, which allows identification of an electronic module. The identifying marker is preferably associated with properties of the electronic element segment of the electronic module. For example, the type of electronic module and the value can both be associated with the identifying marker. The identifying markers can additionally enable detection of orientation of the electronic module. The identifying marker could be a machine-readable code such as a barcode, a QR code, TopCodes, Popcodes, a SnapTag, or any suitable identifying graphic. Alternatively, the computer vision techniques can be used to detect text, colors, shapes used for the electronic modules. In alternative embodiments the set of modules can be construction blocks following any suitable cross interaction rules (arbitrary or natural rules) such as programming blocks or physics blocks. The AR application can preferably be suitably updated to apply to these construction block variations.

### 2. Method for Augmented Reality Feedback in Circuit Construction

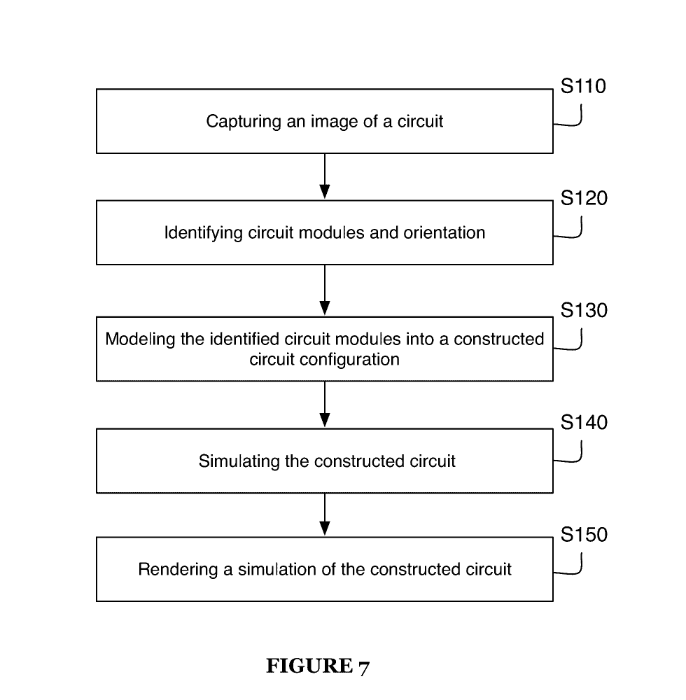

As shown in FIG. 7, a method for augmented reality feedback in circuit construction can include in an application capturing an image of a circuit Silo, identifying circuit modules and orientation S120, modeling the identified circuit modules into a constructed circuit configuration S130, simulating the constructed circuit S140, and rendering a simulation of the constructed circuit S150. The method functions to provide an educational interface to physical interactions and experimentation with circuit elements. Preferably, the method is used with a circuit construction set, and more preferably a circuit construction set such as the one described above. Many concepts in circuits are not intuitive or evident without understanding circuits. An augmented reality application can preferably be used with an electronic construction set such as the one described above to provide feedback, present lessons, enable mixed interactions, and/or other suitable forms of interaction. The method can be implemented for real-time simulation of the circuit where a live video stream of the circuit is captured by the application but may alternatively be used in a snapshot application where a static picture of an application is used. The method is preferably applied to circuit construction sets, but may alternatively be used with other construction blocks such as a “programming” construction blocks to show programming logic through physical block manipulation, and physics construction blocks.

In some embodiments, a method includes scanning a first construction module for a first identifying marker, classifying the first construction module based on the first identifying marker, scanning a second construction module for a second identifying marker, classifying the second construction module based on the second identifying marker, associating the first construction module with the second construction module based on the classification of the first construction module and the classification of the second construction module, and visualizing a construction blueprint based on the association of the first construction module with the second construction module. In some embodiments, the first construction module may comprise an electrical circuit component, such as a resistor, capacitor, or power source, among others. In some embodiments, the first construction module may comprise a plumbing component (e.g. pipe, faucet, etc.), a structural component (beam, wall, etc.), or a programming component (function, declaration, etc.), among others.

In some embodiments, the first construction module and the second construction module may be electric circuit components. The first construction module may be a power supply, and the second construction module may be a wire. A third construction module may be a light source, and a fourth construction module may be another wire. Once the four construction modules have been identified and classified, they are associated with each other based on location and classification. For example, the power supply is associated with the first wire by being connected to it, and associated to the light source by being connected to it via the first wire and second wire. Once all modules have been associated with each other, a construction blueprint may be displayed. The construction blueprint in this example would illustrate how all the modules are connected to each other, and may illustrate the current flowing from the power source through the other modules.

In some embodiments, the construction blueprint may be compared with a template blueprint. For example, a template blueprint may call for a power supply, two light sources in series, and wires connecting the power supply to the two light sources in series. If the construction blueprint only had one light source, the comparison would indicate that the construction blueprint did not match the template blueprint. A suggestion may be displayed, for example, on a mobile device, on how to alter the construction blueprint such that it matches the template blueprint. In this case, the suggestion may be to include a second light source after the first light source in series. Thus, a user may see the suggestion and alter, change, or reorganize the electric circuit contemporaneously or in real time in response to seeing the suggestion. The construction modules may be rescanned to produce a second or rearranged construction blueprint.

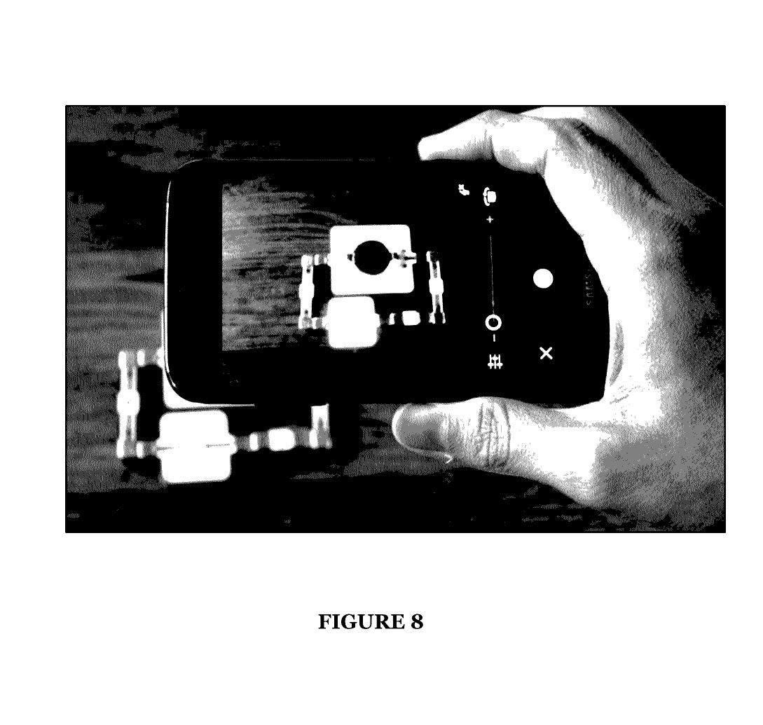

Block Silo, which includes capturing an image of a circuit Silo, functions to obtain a visual representation of a physical circuit construction set. The AR application is preferably operating on a device with an integrated camera, which can capture a picture or video. An external camera may alternatively capture the image, and the image is uploaded or retrieved by the AR application. In implementation, a user will point the camera of the device to capture substantially the entirety of the constructed circuit as shown in FIG. 8. The camera direction is preferably perpendicular to the plan of circuit construction, but the method can preferably support some variance in the angle of imaging provided all the components are viewable and detectable. In one implementation, the method is used on a static image. The image is captured through any suitable camera, uploaded to the application, and then processed to generate a circuit simulation. While the image is static, the simulation may be dynamic and change with time. For example, the current flow can be animated through the circuit. And interactions may be made with the simulated circuit (which may even impact the actual circuit as described below). In another implementation, the method is used on a video image, video is preferably a live view of the circuit, and the simulation and rendering are performed in real-time with the video input. While the method is preferably used to provide AR modeling of one circuit, the method may be used to simultaneously model multiple circuits captured in the image.

In some embodiments, radio frequency detectors may be used to capture an electronic circuit. For example, a resistor module may have a radio frequency emitter that emits at a specific frequency or amplitude. The frequency or amplitude may also telegraph the level of resistivity. A combination of frequencies and amplitudes may be used to convey specific modules. For example, resistor modules may emit at a X Hz frequency with Y amplitude for 1000 ohms, while light source modules may emit at a 2X Hz frequency. Thus, if a detector picked up a radio frequency at X frequency with a 2Y amplitude, the detector will identify that construction module as a resistor with a resistance of 2000 ohms, assuming linear correlation with amplitude and resistivity. Other correlations may be used.

Block S120, which includes identifying circuit modules and orientation, functions to detect circuit modules and the position of circuit modules. Identification of circuit modules preferably identifies an identifying marker. The identifying marker can be a machine-readable code such as a barcode, a QR code, TopCodes, Popcodes, a SnapTag, or any suitable identifying graphic. The identifying marker may alternatively, be the physical construction of an electronic module. The electronic modules, or construction modules in some embodiments, may have physical characteristic shapes, coloring, patterns, labeling, or other distinguishing elements that can be used as identifying markers to identify the module. Each module configuration preferably has a unique identifying marker that can be mapped to the type of module, the value of the module, and optionally any configuration of the module. Configuration of the module may include programming that had been loaded into the electronic module. The orientation of the electronic modules preferably includes position and rotation. Image scale and angle of viewing can additionally be detected.

Block S130, which includes modeling the identified circuit modules into a constructed circuit configuration, functions to use modeled representations of the electronic elements and the information identified in the image to detect how the pieces of the construction set are arranged. The absolute (or relative) size and shape of the electronic modules is preferably stored or accessible by the application. The identity, value, and orientation of Block S120 are then updated with the modeled information to approximate the actual component construction configuration. The constructed circuit configuration is the modeled representation of the circuit captured in the image. Various heuristics and statistical approximations may be applied to best estimate a constructed circuit configuration. For example, a distance threshold may be used to determine when modeled connectors are deemed as forming a connection. The modeled constructed circuit configuration can reduce the construction set pieces to generalized circuit elements. During modeling, the application may additionally alert a user to any errors. One error may be that no electronic modules are recognized. Another error may be if the electronic modules are modeled as projecting out of the view of the image. Feedback may additionally alert the user on how to reposition the camera for improved performance.

In some embodiments, a construction blueprint may be compared with a template blueprint. The template blueprint, in cases where the construction blueprint comprises an electric circuit, may comprise a subset of circuits, such as open circuits and closed circuits. For example, a template blueprint may include an electrical circuit comprising a power source, a wire, a light source, and a second wire.

Block S140, which includes simulating the constructed circuit, functions to generate a circuit simulation from the modeled constructed circuit. Simulating the constructed circuit preferably uses mathematical models of circuit elements to replicate the behavior of the actual electronic circuit. The output of simulation may be scaled according to the information that is selected for presentation. For example, in one variation, the current direction through a circuit network may be the simulated output. In another example, voltage levels may be modeled at different points. In another example, voltage or current can be calculated as a function of time. In one variation, the application may have presented a challenge to the user. And the simulation is based off that objective. The simulation of the circuit evaluated to determine if the current objectives is achieved. For example, one example may be to make an LED light up based on button. If the simulated circuit does not include a switch/button in the circuit that alters the state of an LED then the challenge is not successfully completed. The simulating of the constructed circuit can alternatively generate any suitable set of data evaluating the constructed circuit. While many of the electronic modules may be simple elements such as resistors, LEDs, or capacitors, some electronic modules may be programmable or include some dynamic element. Simulating the constructed circuit may additionally simulate configuration of configurable electronic modules. In one variation, this can include simulating an installed program in one or more electronic modules. For example, a microcontroller module may be programmed with a set behavior. This behavior can be modeled in combination with the connected circuit. In another variation, simulating configuration may include identifying physical configuration such as detection of the state of a switch, or position of a potentiometer. Modules with a communication component may communicate properties of the electronic module to the application. For example, a sensor may transmit the resulting voltage potential from the sensor.

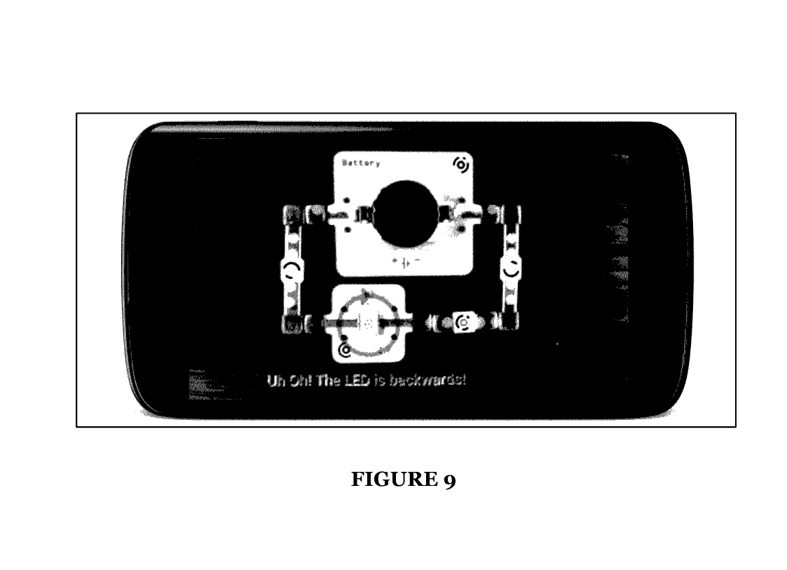

Block S150, which includes rendering a simulation of the constructed circuit, functions to output analysis and feedback from the captured state of the circuit. Preferably, rendering a simulation of the constructed circuit includes rendering a graphical representation of the simulated constructed circuit. As shown in FIG. 9, the graphical representation may overlay an animation of current flow over the image of the circuit. Activity or results relating to particular electronic modules may also be indicated. For example, the voltage at particular point in the circuit may be labeled; the on/off state of an LED module may be shown; and the value of an electronic module may be labeled. In the case that the captured image is a video stream, the simulation of the constructed circuit is preferably rendered over the image of the physical elements in real-time. The rendered image preferably tracks with the change in perspective of the camera. Once a circuit is registered, the user may be able to zoom in on an electronic element (losing sight of other circuit elements) to alter the display mode. For example, zooming in on an electronic element may show a detailed view of that element such as displaying the current, voltage, and other properties.

In addition to presenting information about a current circuit, the method preferably provides additional information. As one aspect, the rendering a simulation can additionally render debugging information. The simulation may identify alternative circuits, or suggestions, that achieve more expected results for the type of circuit. For example, if the circuit includes an LED but the LED has an orientation that prevents current flow, then that electronic module may be highlighted with a debugging indication that the module should be rotated. The application can use debugging events to present new information and educate a user such as explaining that the LED is a diode where current flows from the positive side to the negative side. Rendering of the simulation can additionally be used in combination with a tutorial mode. As opposed to evaluating a finished circuit, the method can be used while constructing a circuit. For example, the application may render the location where a new component should be added to work towards a final circuit. Similarly, the method can include detecting lesson events from the simulated circuit. The lesson events are a set of construction contexts that can trigger various lessons, challenges, and other events on the application. For example, when a new electronic module is used in a circuit, a tutorial may be displayed to the user. The tutorials may be ordered and may be conditional upon progressing through the set of tutorials in substantially some set order. For example, a user may learn about resistors, batteries, and LEDs, and then learns about switches, potentiometers, and photoresistors.

In some embodiments, a score may be associated with each completion of a lesson event. For example, completion of an introductory lesson may award a user 100 points, while completion of an expert lesson may award a user 1,000 points. In some embodiments, the points or scores may be used as currency to buy additional lessons or unlock other features in an application.

In some embodiments, the first construction module's electrical properties may be visualized. For example, visualizing a resistor's electrical properties may include showing how much current is going through the resistor, the voltage drop across the resistor, or the power dissipated by the resistor, among others.

The method can additionally include receiving user input through the application and communicating an element augmentation to an electronic module, which functions to allow interactions with the simulated circuit to impact the physical circuit. The interactions are preferably received through a graphical user interface of the circuit overlaid on top of the circuit. For example, if a user selects a switch rendered on the application, the application may communicate with the switch module and alter the state of the switch to correspond with the state of the application. Similarly, input from an electronic module can be communicated to the application, and then update the simulated circuit rendered. For example, if the user changes the state of a switch, that change may be communicated to the application, and the circuit simulation altered accordingly.

The system and method of the preferred embodiment and variations thereof can be embodied and/or implemented at least in part as a machine configured to receive a computer-readable medium storing computer-readable instructions. The instructions are preferably executed by computer-executable components preferably integrated with the electronic construction set. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.”

As a person skilled in the art will recognize from the previous detailed description and from the figures and claims, modifications and changes can be made to the preferred embodiments of the invention without departing from the scope of this invention defined in the following claims.

What is claimed is:

1. A method, comprising:
scanning a first construction module for a first identifying marker;
classifying the first construction module based on the first identifying marker;
scanning a second construction module for a second identifying marker;
classifying the second construction module based on the second identifying marker;
associating the first construction module with the second construction module based on the classification of the first construction module, the classification of the second construction module, and the location of the first construction module and the location of the second construction module; and
visualizing a construction blueprint based on the association of the first construction module with the second construction module.

2. The method as recited in claim 1, wherein scanning the first construction module includes scanning the first construction module with a camera on a mobile device, and wherein displaying the construction blueprint includes displaying the construction blueprint on the mobile device.

3. The method as recited in claim 1, wherein the first construction module comprises an electrical circuit component.

4. The method as recited in claim 2, wherein the first identifying marker comprises at least one from the group comprising: barcode, QR code, TopCodes, Popcodes, SnapTag, and physical characteristics of the first construction module.

5. The method as recited in claim 1, further comprising comparing the construction blueprint with a template blueprint.

6. The method as recited in claim 5, the method further comprising displaying on a display screen an indication that the construction blueprint does not match the template blueprint and displaying a suggestion on how to match the construction blueprint with the template blueprint

7. The method as recited in claim 3, further comprising indicating an open circuit if such exists in the construction blueprint.

8. The method as recited in claim 7, the method further comprising scanning the first construction module and the second construction module after changes have been made to the organization of the first construction module and the second construction module to determine if the construction blueprint matches the template blueprint.

9. The method as recited in claim 7, wherein the suggestion includes adding a third construction module.

10. The method as recited in claim 3, further comprising displaying an electric property at the first construction module. ii. The method as recited in claim 5, wherein points are awarded to a user based on the comparison.

12. The method as recited in claim 5, further comprising revealing a second template blueprint to a user if the construction blueprint matches the template blueprint.

13. The method as recited in claim 5, wherein the blueprint template and the construction blueprint comprise electrical circuit schematics.

14. The method as recited in claim 1, wherein scanning the first construction module includes scanning the first construction module with a radio frequency detector.

15. The method as recited in claim 14, wherein the first identifying marker comprises a first radio frequency.

16. A method comprising:
capturing an image of a circuit;
identifying circuit modules and orientation;
modeling the identified circuit modules into a constructed circuit configuration;
simulating the constructed circuit; and
rendering a simulation of the constructed circuit on a display device.

17. The method as recited in claim 16, further comprising comparing the identified circuit modules and orientation to a template circuit modules and orientation.

18. The method as recited in claim 17, further comprising displaying an error message on the display device if the identified circuit modules and orientation do not match the template circuit modules and orientation.

19. The method as recited in claim 17, further comprising:
capturing an image of a rearranged circuit, wherein the rearranged circuit is the result of a user contemporaneously rearranging the circuit;
identifying rearranged circuit modules and rearranged orientation;
modeling the identified rearranged circuit modules into a rearranged constructed circuit configuration;
simulating the rearranged constructed circuit; and
rendering a simulation of the rearranged constructed circuit on a display device.

20. The method as recited in claim 19, further comprising comparing the rearranged identified circuit modules and rearranged orientation to a template circuit modules and orientation, and if the rearranged identified circuit modules and rearranged orientation match the template circuit modules and orientation, prompting a user to construct another circuit.
